(19) United States
(12) Patent Application Publication
(10) Pub. No.: US 2016/0309749 A1
(43) Pub. Date: Oct. 27, 2016

(54) PALATABILITY ENHANCER WITH ADDED AROMA FOR APPLICATION TO PET FOOD PRODUCTS

(71) Applicant: Wal-Mart Stores, Inc., Bentonville, AR (US)

(72) Inventors: Jamie Russell Perez, Siloam Springs, AR (US); Timothy John Dodge, Bentonville, AR (US)

(21) Appl. No.: 15/133,427

(22) Filed: Apr. 20, 2016

Related U.S. Application Data
(60) Provisional application No. 62/152,157, filed on Apr. 24, 2015.

(51) Int. Cl. A23K 40/30; A23K 50/42; A23K 10/20; A23K 10/26; A23K 10/30

(52) U.S. Cl. CPC A23K 40/30; A23K 10/26; A23K 10/30; A23K 10/20; A23K 50/42

(57) ABSTRACT

A palatability enhancer with added aroma for application to pet food products and method of applying the aroma to dry pet food product is provided. A method for adding liquid aroma to a dry pet food product includes coating the dry pet food product leaving a dryer of a dry pet food manufacturing plant with a composition comprising a mixture of liquid palatability enhancers and liquid aroma. The method also includes applying a coating of digest over the coating of composition of liquid palatability enhancers and liquid aroma. The coating of digest over the coating of composition of liquid palatability enhancers and liquid aroma seals the aroma into the dry pet food. The finished dry pet food product then includes an aroma that increases the humanization sensory factor to the dry pet food product without a negative sensory impact for the pets that will consume the dry pet food product.

### RELATED APPLICATION

This application claims priority to U.S. Provisional Patent Application Ser. No. 61/152,157 to Wal-Mart Stores Inc., filed Apr. 24, 2015 and entitled “Palatability Enhancer with Added Aroma for Application to Pet Food Products”, which is hereby incorporated entirely herein by reference.

### FIELD OF THE INVENTION

The invention relates generally to pet food products, and more specifically, to a palatability enhancer with added aroma for application to pet food products.

### BACKGROUND

Commercial dry pet food, often referred as kibble, currently contains no detected aromas because of the moisture or dryness factor of the kibble. The application of aroma to kibble requires a special formulation and/or special equipment. This additional processing equipment required to apply aroma to kibble is expensive and adds to the overall process complexity, resulting in increased product cost.

### BRIEF SUMMARY

In another aspect, provided is a method for a method for adding liquid aroma to a dry pet food product, the method comprising: coating the dry pet food product leaving a dryer of a dry pet food manufacturing plant with a composition comprising a mixture of liquid palatability enhancers and liquid aroma; and applying a coating of digest over the coating of composition of liquid palatability enhancers and liquid aroma.

In one aspect, provided is a dry pet food product comprising: kibble; and an aroma added to the kibble by coating the kibble leaving a dryer of a dry pet food manufacturing plant with a composition comprising a mixture of liquid palatability enhancers and liquid aroma; and applying a coating of digest over the coating of composition of liquid palatability enhancers and liquid aroma.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a flow diagram illustrating a pet food production process, in accordance with some embodiments.

FIG. 2 is a flow diagram illustrating a method for adding aroma to a dry pet food product, in accordance with some embodiments.

### DETAILED DESCRIPTION

Dry pet food, or kibble, is commonly used by pet owners to feed their pets and provide the pets with the proper nourishment and to fill dietary needs. Kibble generally has an off putting smell to humans. Embodiments of the present invention includes kibble with aroma ingredients added that does not require specialty equipment or additional processing steps, and further the aroma increases the humanization sensory factor to dry kibble without a negative sensory impact for the pets.

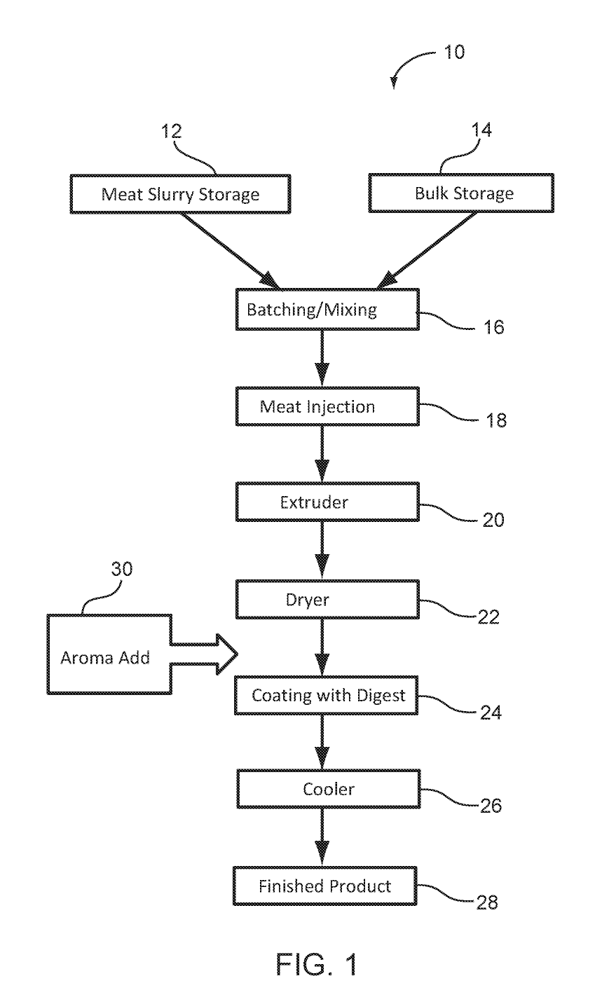

FIG. 1 is a flow diagram illustrating a pet food production process 10 performed by a pet food manufacturing plant in which embodiments of the present inventive concepts are employed. The process 10 may begin at a meat slurry storage 12 and a bulk storage 14. Meat slurry from the meat slurry storage 12 and bulk from the bulk storage 14 is combined in a batching/mixing process 16. After the slurry and bulk are batched and mixed, a meat injection process 18 injects meat into the mixture. The mixture may now include ingredients such as protein sources like beef and chicken, as well as grains, cereals, vitamins, minerals, and antioxidants. These ingredients are mixed together in order to make a consistent dough type product that can be cooked. This mixture may include all of the pet nutritional needs.

This dough is then fed into an extruder 20, wherein the dough is typically placed under pressure and high temperature. The dough is forced through dies of the extruder 20 to form particular shapes. As the dough is forced through the dies, a knife operates to cut the dough and as they are cut, the lack of pressure as it leaves the extruder 20 results in a puffing up effect of the dough.

The puffed dough pieces are then passed through a dryer 22 so that any remaining moisture is drawn out. The dough has now been transformed into kibble. The kibble is then placed on a belt and for coating with a digest 24 by being sprayed with fats. However, embodiments of the present invention include adding aroma 30 prior to coating with digest 24. The aroma may be a liquid aroma that is added to liquid palatability enhancers. The liquid mixture of palatability enhancers and aroma may be sprayed onto the kibble after it leaves the dryer. This allows for better absorption due to the heat at which the kibble is. By adding aroma 30 prior to coating with digest 24, the coating with digest operates to seal the aroma onto the kibble. The coated kibble is then directed through a cooler 26 and then the product is finished 28 by being sealed in packages.

The patentability enhancers may be in a liquid composition that provides a taste, smell, texture, and/or the like that is pleasant to the pet. The aroma may also be a liquid that is mixed with the palatability enhancers. In some embodiments, the amount of aroma may be within the range of 1% to 5% based on weight of the total composition of the palatability enhancers and aroma. In this embodiment, the amount of palatability enhancers may be within the range of 95% to 99% based on weight of the total composition of the palatability enhancers and aroma. In other embodiments, the amount of aroma may be within the range of 2% to 3% based on weight of the total composition and the amount of palatability enhancers may be within the range of 97% to 98% based on weight of the total composition. In yet another embodiments, the amount of aroma may be approximately 2% based on weight of the total composition and the amount of palatability enhancers may be approximately 98% based on weight of the total composition.

The use of liquid aroma and liquid palatability enhancers is an important element of embodiments of the present invention. The cost of using liquid aroma and liquid palatability enhancers is much lower than the use of dry aroma product. Further, the mixing of the aroma and the palatability enhancers is made easier by use of liquid aroma and liquid palatability enhancers because there is not the need to allow time for dissolving of the dry aroma product in a carrier or a liquid palatability enhancer.

The aroma may be a human aroma. Human aroma may include aroma such as grilled, sweet and the like. This allows for the kibble to be pleasant in smell to humans as they feed their pets, but at an amount that does not negatively affect the pet's desire to eat the kibble. The human aroma operates to cover or replace the kibble aroma.

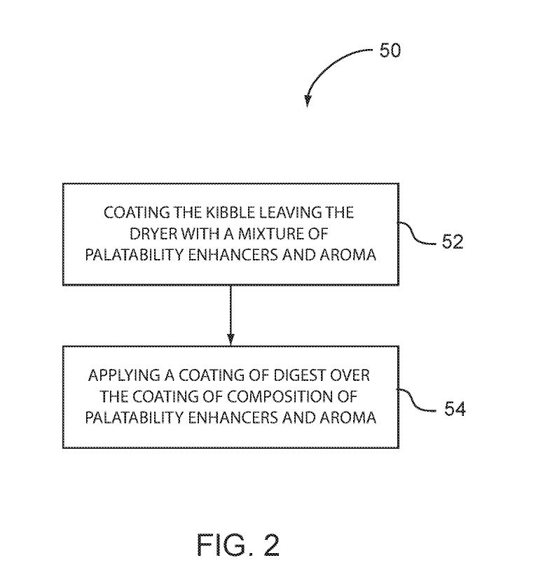

FIG. 2 is a flow diagram illustrating a method 50 for adding aroma to a dry pet food product, in accordance with some embodiments. Some or all of the method 50 can be performed in the process 10 illustrated in FIG. 1. Accordingly, in describing the method 50, reference is made to FIG. 1. Alternatively, some or all of the method 50 can be performed with any production process without the need of additional equipment for specialty processing.

The method 50 can be initiated at block 52, by coating the kibble leaving the dryer with a mixture of palatability enhancers and aroma. The composition of palatability enhancers and aroma may be sprayed on the kibble while the kibble is transported to the cooler on a belt. In other embodiments, the composition of palatability enhancers and aroma may be sprayed onto the kibble in a drum while the kibble is agitated in order to coat all of the kibble with the composition of palatability enhancers and aroma.

The method may include applying the aroma without the use of specialty equipment or the addition of another processing step. The present invention allows processing plants and manufacturers to add aroma without the costs associated with introducing new machines and processes within the normal product of kibble. Further, the aroma may be varied and changed within the same production line simply by changing the supply of the palatability enhancers with a different added aroma.

At block 54, the method 50 may include applying a coating of digest over the coating of composition of palatability enhancers and aroma. The coating of digest further includes the step of sealing the aroma within the kibble.

Another embodiment of the present invention is a product made by the process shown in FIG. 1 and/or the process shown and described with regard to FIG. 2. For example, the embodiment may include a pet kibble formed by a method of coating the kibble leaving the dryer with a mixture of palatability enhancers and aroma and applying a coating of digest over the coating of composition of palatability enhancers and aroma. The aroma may be a human aroma. The aroma has a concentration of approximately 2% based on weight of the composition of the palatability enhancers and aroma.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A method for adding liquid aroma to a dry pet food product, the method comprising:
coating the dry pet food product leaving a dryer of a dry pet food manufacturing plant with a composition comprising a mixture of liquid palatability enhancers and liquid aroma; and
applying a coating of digest over the coating of composition of liquid palatability enhancers and liquid aroma.

2. The method of claim 1, wherein coating the dry pet food product occurs prior to entering a cooler of the dry pet food manufacturing plant.

3. The method of claim 1, wherein the liquid aroma is a human aroma.

4. The method of claim 3, wherein the human aroma is a grilled aroma.

5. The method of claim 3, wherein the human aroma is a sweet aroma.

6. The method of claim 1, wherein the composition of liquid palatability enhancers and liquid aroma comprises an amount of liquid aroma is within the range of 1% to 5% and the amount of palatability enhancers is within the range of 95% to 99% based on weight of the total composition of the liquid palatability enhancers and liquid aroma.

7. The method of claim 1, wherein the composition of liquid palatability enhancers and liquid aroma comprises an amount of liquid aroma is within the range of 2% to 3% and an amount of palatability enhancers is within the range of 97% to 98% based on weight of the total composition of the liquid palatability enhancers and liquid aroma.

8. The method of claim 1, wherein the composition of liquid palatability enhancers and liquid aroma comprises an amount of liquid aroma is approximately 2% and an amount of palatability enhancers is approximately 98% based on weight of the total composition.

9. The method of claim 1, wherein coating the dry pet food product is performed without adding equipment and processing steps to the manufacture of the dry pat food product.

10. The method of claim 1, wherein the applying a coating of digest over the coating of composition of liquid palatability enhancers and liquid aroma further comprises sealing the aroma within the dry pet food product.

11. A dry pet food product comprising:
kibble; and
an aroma added to the kibble by coating the kibble leaving a dryer of a dry pet food manufacturing plant with a composition comprising a mixture of liquid palatability enhancers and liquid aroma; and applying a coating of digest over the coating of composition of liquid palatability enhancers and liquid aroma.

12. The product of claim 11, wherein the liquid aroma is a human aroma.

13. The product of claim 12, wherein the human aroma is a grilled aroma.

14. The product of claim 12, wherein the human aroma is a sweet aroma.

15. The product of claim 11, wherein the composition of liquid palatability enhancers and liquid aroma comprises an amount of liquid aroma is within the range of 1% to 5% and the amount of palatability enhancers is within the range of 95% to 99% based on weight of the total composition of the liquid palatability enhancers and liquid aroma.

16. The product of claim 11, wherein the composition of liquid palatability enhancers and liquid aroma comprises an amount of liquid aroma is within the range of 2% to 3% and an amount of palatability enhancers is within the range of 97% to 98% based on weight of the total composition of the liquid palatability enhancers and liquid aroma.

17. The product of claim 11, wherein the composition of liquid palatability enhancers and liquid aroma comprises an amount of liquid aroma is approximately 2% and an amount of palatability enhancers is approximately 98% based on weight of the total composition.
